(19) United States
(12) Patent Application Publication
(10) Pub. No.: US 2007/0124400 A1
(43) Pub. Date: May 31, 2007

(54) Sub Accounts System and Method

(75) Inventor: Eric A. Lee, San Diego, CA (US)

Correspondence Address: NORTH OAKS PATENT AGENCY, 45 ISLAND ROAD, NORTH OAKS, MN, 55127, US

(73) Assignee: Digital River, Inc., Eden Prairie, MN (US)

(21) Appl. No.: 11/565,613

(22) Filed: Nov. 30, 2006

Related U.S. Application Data
(60) Provisional application No. 60/741,493, filed on Nov. 30, 2005.

(51) Int. Cl. G06F 15/16

(52) U.S. Cl. 709/206

(57) ABSTRACT

A software system that utilizes a computerized messaging system with sub accounts for use on the internet or other network is described. A sub account lets the user establish multiple levels of access within the email system. As the administrator, the user may set up additional accounts and determine the types and levels of access users of those accounts will have.

### RELATED APPLICATIONS

This application claims the benefit of U.S. Provisional Application No. 60/741,493 filed Nov. 30, 2005, entitled “Sub accounts Enhancement,” which is incorporated herein by reference.

This application is related to co-pending:
U.S. patent application Ser. No. 11/______, filed Nov. 30, 2006, entitled “Subscriber List System and Method”;
U.S. patent application Ser. No. 11/______, filed Nov. 30, 2006, entitled “Recurring Message System and Method”; and
U.S. patent application Ser. No. 11/______, filed Nov. 30, 2006, entitled “Dynamic Content System and Method”, all of which are herein incorporated by reference.

### FIELD OF THE INVENTION

The present invention relates to electronic messaging systems for use on the internet. More particularly, the present invention relates to a system and related tools for creating and managing sub accounts.

### BACKGROUND OF THE INVENTION

Targeting customers with e-mail marketing is like going on a date. The electronic commerce (e-commerce) company makes the customer comfortable by providing information, and the customer tries to understand what the e-commerce company is all about. If the customer likes the e-commerce company there is a second date, and then eventually marriage.

E-commerce companies love e-mail, and for good reason. Production costs are low; results are immediate. Personalized e-mail are messages that consumers sign up to receive or that companies can target at customers based on their previous purchases. Furthermore, targeted e-mail marketing requires a much bigger investment than simply blasting out untargeted e-mail messages because it involves sophisticated databases and statistical modeling.

Targeted e-mail is also more prone to error. Sending a personalized message to the wrong person can ruin a relationship for life. So can a message that overloads a customer's computer. But as long as the e-commerce company chooses the right words and format, experts agree that talking to customers is not only good for sales but also good for name recognition. Any excuse to interact with your customer is healthy for the brand, and targeted e-mail seems to be one of healthiest direct-marketing ways to build brand equity.

Accordingly, the ability to market a product or service to individuals who are accessible on the Internet is becoming increasingly important. Email systems exist today for sending email to a target set of email addresses for purposes such as marketing, information acquisition, and otherwise. A system for sending email to a number of email targets for such purposes may be called an email campaign.

Present email campaigns may suffer from difficulties in locating a pool of relevant individuals to be contacted. In a small email campaign, each email sent is critical to the success of the campaign, and needs to be carefully created. In other situations, large numbers of individuals to be contacted may have been found. This may result in increased difficulty in tailoring the large number of required email messages to the individuals for more effective contact.

Furthermore, once an email campaign has been initiated, difficulties in measuring success of the email campaign are presented. Effective ways for determining whether email recipients have received email from the email campaign have been sought. Also, effective ways for allowing the email recipients to provide feedback have also been sought. It is desirable for the email recipients to be able to respond with feedback, and for the quantity and content of the responses to be monitored and tracked. Furthermore, conducting advanced database search queries, then saving and managing these searches automatically is desirable as well.

Respecting subscribers to an email is also important. A message that's too focused risks missing out on impulse or crossover buys. According to a recent survey by Return Path, the number of consumers who are reporting opt-in email as spam to their Internet Service Provider (ISP) is up from 23.4% at the end of 2004 to nearly 34% at the end of 2005. The top reasons cited for the increase are lack of content relevancy and ratcheting up frequency beyond subscriber expectations. Moreover, according to a new Hostway survey, 70% of consumers said they would not purchase from websites that committed these pet peeves: pop-up advertising, registration log-on pages, software installation, and slow-loading pages. In addition, there is powerful evidence citing how effective email is when driving traffic to an online sale. In a recent Email Insider report, retailers who used email to promote post-holiday sales saw traffic increases of up to 700% above pre-holiday numbers.

Email deliverability will continue to be a major issue, and there are several deliverability challenges. Some, like authentication methods and challenge-response functionality, will be addressable by meeting technological specifications. But the most important factors affecting deliverability will continue to be reputation and respectful sending practices.

Furthermore, e-marketers' use of segmentation strategies and testing will become increasingly sophisticated. Marketers are getting smarter, and the technology is, too. Upcoming advances in email functionality like easier-to-use dynamic content, more robust testing capabilities, and deeper integration with web analytics providers will give businesses even more actionable information to drive sales and build relationships.

Additionally, there is a right and wrong way to build a list. A list is basically a database of subscribers. If a business wants to build an email marketing program, the best thing is not to purchase or borrow a list. Otherwise, they will be reported as a spammer. The best, most effective way to obtain a good list is to build it from the ground up. Building a database doesn't have to be difficult. In fact, it is one of the best ways to streamline marketing strategy to deliver measurable returns. In growing a quality permission—based list, the website is the best and most obvious place to build a list. If someone is surfing on the website, the business has a stellar opportunity to transform a web user from an interested party to a loyal patron. Usually there will be some link on the website that asks users to “Register Now” or “Subscribe Today” for a free e-newsletter, for more information, or for exclusive sales, offers and promotions. A survey page that is easy to fill out (name and email address are most important) is the next step. This information can then be used in a database.

The most time honored marketing method is word of mouth. Accordingly, using the current database to tell their friends about the business is a proven way to grow list. Using forward-to-a-friend and refer-a-friend tools, the audience will grow exponentially. These tools coupled with creative promotions such as special offers or drawings for those who refer friends, can build the subscriber base even more. But, as with any email marketing method, it must be used mindfully, employing permission-based methods only.

Great lists, like great buildings, are not built overnight. It takes time, often a few years, to grow a list that delivers big returns. A slowly built list ensures that users grow a community of patrons who rarely opt out. Email marketing campaigns are best implemented when integrated with and supported by other marketing efforts. That means the email marketing strategy should be part of printed collateral, in store and on-location promotions, advertising and trade show booth promotions. Every piece of paper about the business should include a link to the website and email subscription information.

The present invention provides a solution to these needs and other problems, and offers other advantages over the prior art.

### BRIEF SUMMARY OF THE INVENTION

The present invention relates to electronic messaging systems for use on the internet. It is a system and related tools for creating and managing sub accounts. In accordance with one embodiment of the invention, a computerized messaging system with sub accounts for use on the internet or other network is described. Sub accounts let the user establish multiple levels of access within the email system. As the administrator, the user may set up additional accounts and determine the types and levels of access users of those accounts will have.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates a sub account create new account user interface.

FIGS. 2 through 6 illustrate more details of the sub account create new account user interface

FIG. 7 illustrates a Venn diagram of subscribers.

FIG. 8 illustrates a message approval process flowchart.

### DETAILED DESCRIPTION

In a preferred embodiment, sub accounts allows the user to establish multiple levels of access within their email system. Furthermore, as an administrator, the user may set up additional accounts and determine the types and levels of access other users of those accounts will have. The administrator may also create “unrestricted” sub accounts. Users of these accounts have full access to all system functions, but they can not modify the administrative account information. It will be evident to one of ordinary skill in the art that such a feature might be useful in a corporate environment. For example, the head of a marketing department might have administrative control of the system, while a department employee would have operational control.

### Creating a New Sub Account

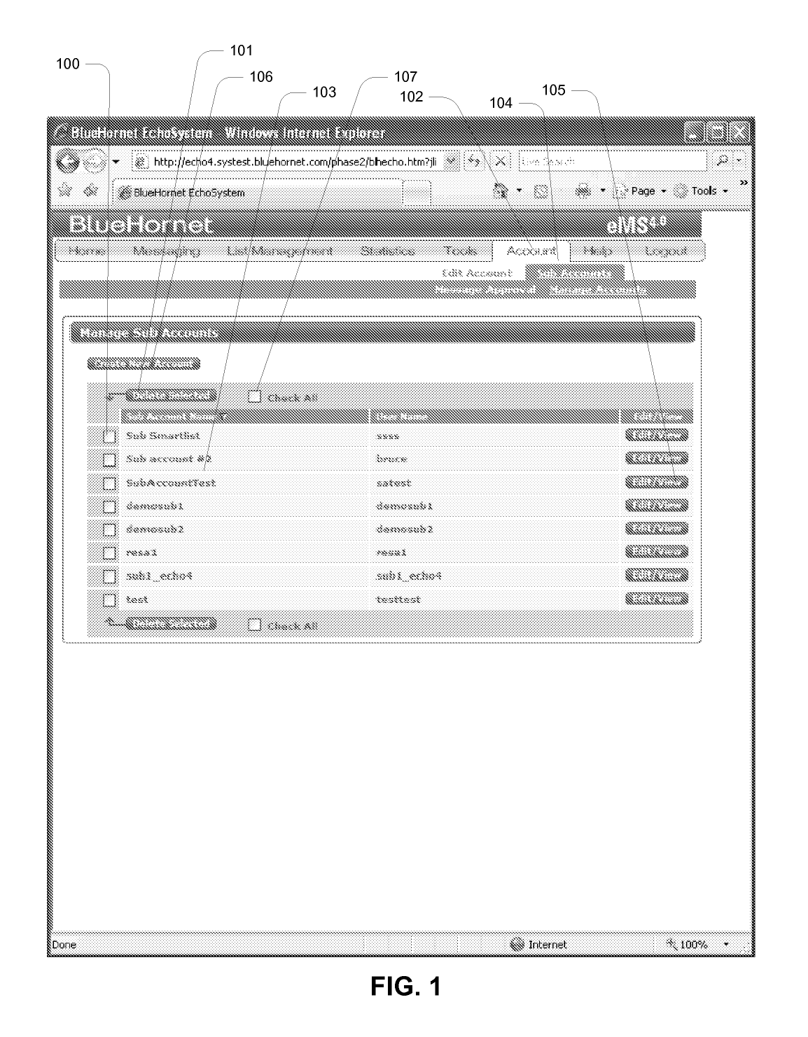

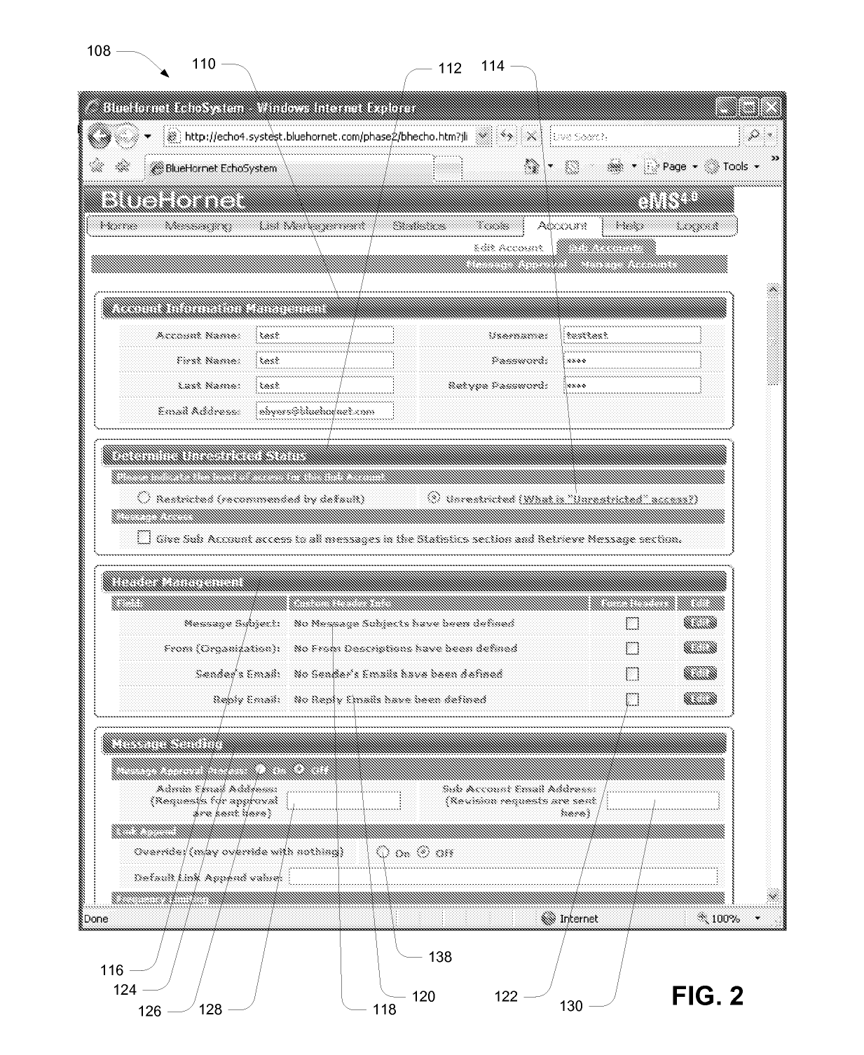

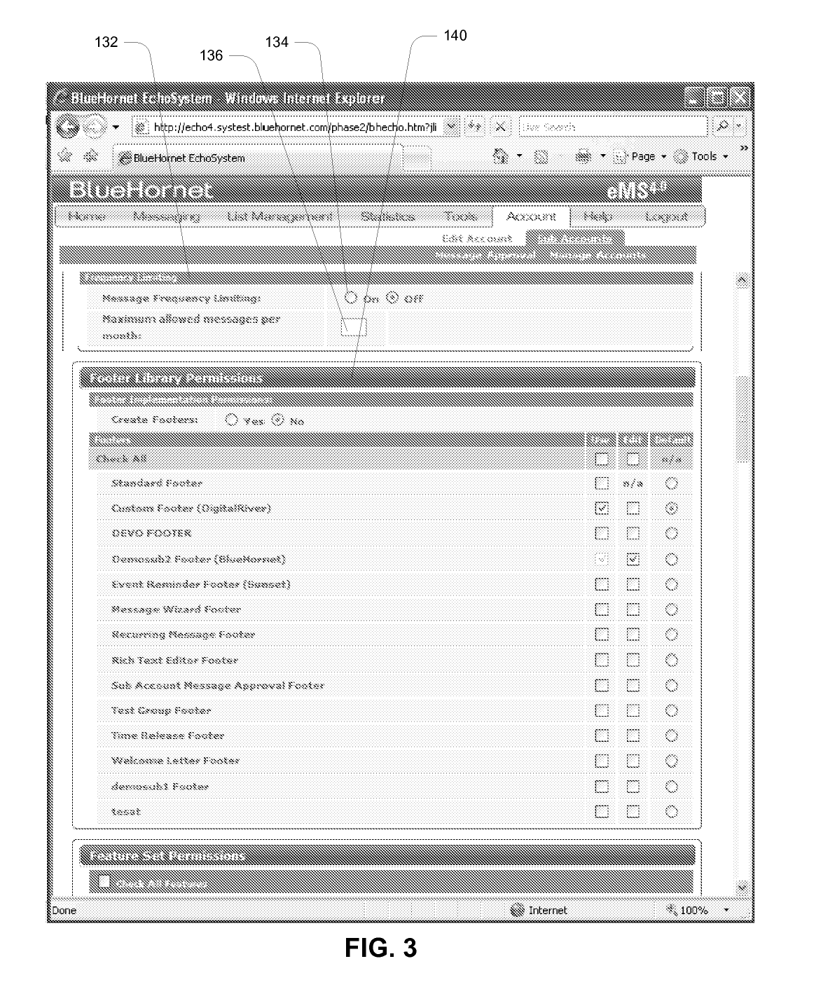

For the first step shown in FIG. 1, the user navigates to “Accounts” 102 and then “Sub Accounts” 104. The user then clicks “Create New Account” 106. Furthermore if a large amount of sub accounts exist sorting options are available to the user to better allow them to quickly access their accounts. They may sort by account name or username. By default, the tool sorts by account name. As shown in FIGS. 2 and 3, the user will see an account creation page 108. In the “Account Information” section 110, the user enters the name of the account user, the username and the password. The user may sort by this name later when viewing all of their sub accounts. It will be evident to one of ordinary skill in the art that the username may be unique across all client accounts and sub accounts. The sub accounts system will do a check to make certain that it is unique, and if not, will alert the user in a javascript popup that they need to choose a new one. Moreover, message sending will also show the account names when the sub account sends a message, the account name will appear next to message sent in the “Statistics” session so that the master account will know which sub account sent which message. Second, if the master account enables the message approval process, then the approval request emails will have the account name in them so that they can quickly recognize who is requesting message approvals.

The next section 112 gives the user an opportunity to choose whether the sub account they are creating will have restricted or unrestricted status. An explanation of an unrestricted sub account is provided in the “What is “Unrestricted” access?” link 114 located to the right of the unrestricted access radio button. The user may click this link 114 a second time to hide the explanation.

By default, all sub accounts “are restricted.” Access is limited to the following: No access to the pool of subscribers who are not in any group; No access to the Edit Account page; No access to the Message Footer page; No access to the Invalid and Bounced sections in the Search Subscribers feature; No access to the Edit Groups feature; No access to the Standard Survey tool; No access to the Edit Categories feature; No access to the Custom Fields feature; Can only see messages sent by themselves in the statistics page; Can only see messages composed by themselves in the draft area of Retrieve Messages; Can only see messages sent by themselves in the sent message area of Retrieve Messages. Also, the benefits of an account that is “unrestricted” is that they get access to everything that a restricted account, as defined above, does not. The user also gains access to the editing, messaging footer, invalid and bounced sections, editing groups, editing categories, and custom field's features.

Another feature is access to the subscribers not part of any group. The user is allowed to use a search tool to search for these subscribers. The user is also allowed to send to these subscribers with the “All Contacts” checkbox in “Choose Recipients.” Furthermore, the administrator may see all messages sent by everybody in the statistics section, draft area, and sent message area. That includes themselves, other sub accounts, and the master account.

### Header Administration

In a preferred embodiment of sub accounts system, headers can be administered. In the “Header Management” section 116, the administrator can create default message settings for their sub account. The administrator can provide a list of default message subjects 118 that this account user can choose from. The administrator may also provide a default “Reply” email address 120 for consistent communications. Moreover, the administrator may make the use of their settings mandatory by clicking the appropriate force headers check box 122 in this section.

The following header sections can be “forced” or suggested to the sub accounts: message subject, from description, reply email, and senders email. To create the subject, from description, reply email, and senders email headers, the user clicks on the “Edit” button for each corresponding row. A popup window will appear which gives the user the ability to add or edit existing headers. They may add up to five headers at once. As each header is added, it will become automatically “visible” for that particular sub account. This means that they will be the headers given as choices in a dropdown menu to the sub account when they create each message.

Moreover, every time a master account adds a header it will be added to a master “pool” of either from descriptions, senders emails, or reply emails so that if the master account creates another sub account and needs to add some headers, they do not have to create all new headers for each of the three necessary types. The master account only needs to go in and make them “visible,” thus turning them on for each new sub account when needed. When the checkbox for each header type is checked, a dropdown will appear for each header type in the rich text message and message wizard pages for which headers are entered. This forces the sub account to choose between a fixed number of choices of headers for their messages.

When the “Force Header” checkbox 122 is unchecked, a dropdown appears below a text input box, much the same way it does beneath the substitute name dropdown. When a selection is made from the header dropdown, it populates the text input with that choice. This makes it clear to the sub account that the headers given are merely a type of suggestion, and allows them freedom to type in any header description or email address into this box that they wish.

### Message Sending

Another feature of sub accounts enhancement system is a message approval process. The master account can turn the message approval feature on or off. If turned on, the “Submit” buttons in a message wizard turn into “Submit for Approval” buttons. Below the “Header Management” section 116, the administrator has the ability to control Message Sending 124. These options include “Message Approval”, default “Link Append” options, “Frequency Limiting” and customized footers.

Another aspect of sub accounts is a message approval process. For “Message Approval”, the administrator can choose what messages are sent from this sub account by maintaining control over the approval process. If, for instance, the administrator would like to maintain message approval control, they would click the appropriate radio button 126 and insert their email address 128 and the email address of the sub account user 130.

Also, the administrator email address is the email address that requests for approval are sent to every time a sub account clicks on the “Submit for Approval” button in either message-sending process. The following information will be included in the email to act as a quick summary of the message waiting for approval: sub account's account name, subject of message, and time of message is intended to go out (immediately or by specified time).

Furthermore, the sub account email address is the email address where revision notices are sent if the master account does not approve of the message. In the message approval tool, the master account can review each message awaiting approval, and if it requires revision, they have the chance to enter a description of why the message needs revision. This message will be included in the email sent to this email address.

Another aspect, shown in FIG. 3, of this invention is “Frequency Limiting” 132. “Frequency Limiting” gives administrative control over how many messages a sub account is allowed to send per month. To establish a frequency limit, the administrator clicks the appropriate radio button 134, and then sets the maximum number of messages allowed 136. When this sub account has reached its monthly limit, the “Send” button that is normally available after composing a message will not be available. By enabling the “Frequency Limiting” feature, they can see how many remaining messages the account can send for the month next to the input box where they specify the numerical limit. Furthermore, the “Remaining” messages display is another aspect. When the frequency limiting radio button is set to “on,” this display appears and is dynamic depending upon what value is entered as well as handles some emergency error checking. Typing in a number in the frequency input text box will automatically reflect a real-time number in this display. For example, if, when this sub account page was loaded, the sub account had already sent three messages this month and the master account enters in a value of “4”, then this display will automatically display that there are “1 message left to send this month.” If the number entered is equal to or less than the number already sent to this month, then it will display 0 (zero) “messages left to send this month.” The master account can only enter numeric values in this box. If they enter any alpha characters or anything that is not a numeric value, it will enable a java script popup that warns, “Please enter only numbers for the monthly maximum.” It will then automatically delete any non-numeric value.

In another embodiment, “Default Link Append” and “Custom Footer” are options. To specify a default link append for a sub account, the administrator simply activates this feature 138 and types the append code they wish to enforce. When this option is active, the sub account user will not be able to modify the link append code. This feature is useful when combined with web analytics tools to track statistics for a sub account's campaigns.

### Custom Footers for Sub Accounts

In the preferred embodiment of sub accounts enhancement system, the user may create custom footers for sub accounts. The “Custom Footer” option 140 allows the administrator to create a unique footer for the sub account if desired. The user may use a footer separate from the master account. They may choose this option if, for example, the user's campaigns differ in look and feel from the administrators. When this radio selection is set to “yes,” it forces the sub account to use the footer text as created below in the edit popup. It replaces the standard and custom footers that the master account has previously defined for a top-level account. In editing the custom footer, the user clicks the “Edit” button, and that will bring up a popup window with a rich text editor where the master account may compose their own custom footer as well as a text area text box for the plain text version of the custom footer. Clicking on the “View” button will bring up the popup window with a preview of the rich text and plain text footers as created above in the “Edit” section. It will be understood that by default, the restricted sub account does not have access to edit its own footer, either through the edit account page or through the messaging and message footer selection from the top navigation.

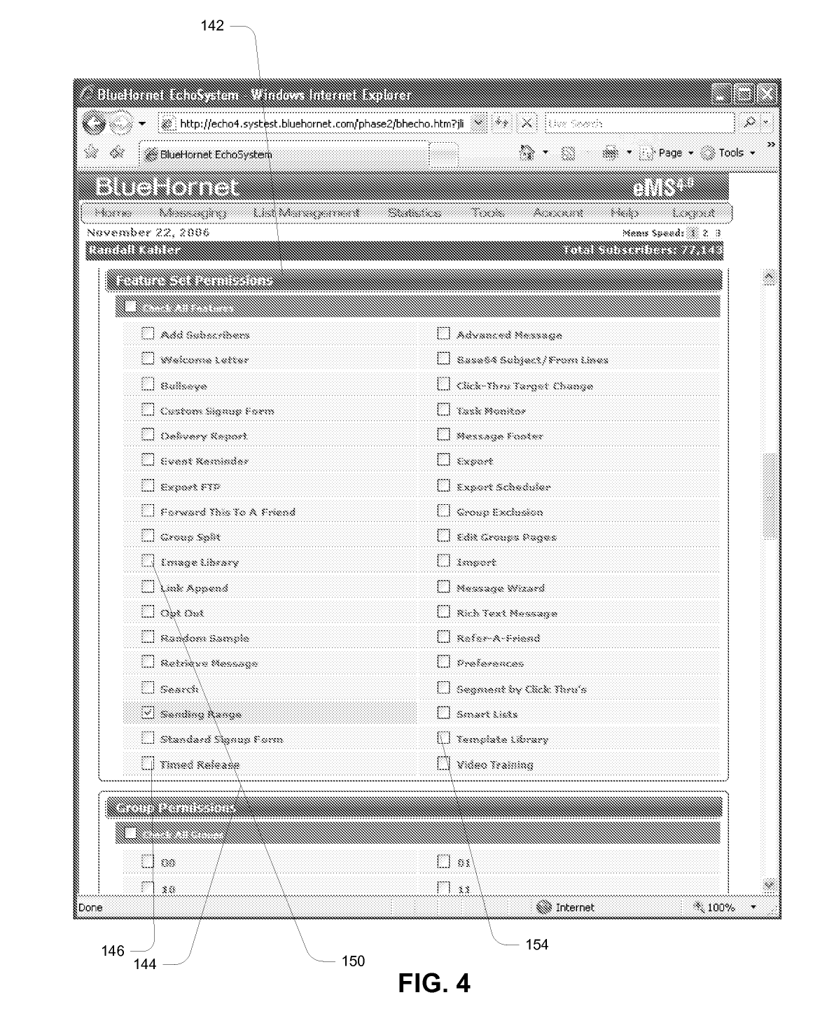

The next two options, shown in FIG. 4 are the Feature Set 142 and Group Permission 144 options, which lets the user choose the features and groups this sub account has access to.

### Feature Set Permissions

Checking an item in the features set section 142 will make it appear as a menu option for this sub account user. If the user leaves a feature unchecked, that menu option will not appear for the sub account user. For example, if the user disables time release 146 for an account by leaving it unchecked, the only option available for the sub account user will be “Send Now” unless they have Message Approval enabled. If Message Approval is enabled, the only option available to the sub account user will be “Submit for Approval.” Furthermore, the check all checkbox allows the master account to select or de-select all of the features that they have access to as administered by their own reseller. Any number of features can be displayed here depending upon how many features the master account's reseller has given them access to. There are two features that, when turned on or off, affect other sections of this sub account management page. First, the image library, when turned on (checked), the image library section below is fully enabled. When turned off (unchecked), the image library section below is all disabled so that they can no longer adjust the granular permissions of the following features: image upload, image rename, and image delete. When turned on (checked), the template library section is fully enabled. When turned off (unchecked), these parts of the template library section are no long available for enabling: ability to add templates to library, template modify permissions, and template delete permissions. When the check all checkbox is checked and the image library and/or template library permissions exist for this particular master account, then their corresponding special sections below should be enabled. If the check all checkbox is unchecked and the image library and/or template library permissions exist for this particular master account, then their corresponding sections should be disabled. When clicking on them this should reflect accurately as well as if these features exist that way upon loading the page.

### Group Permissions

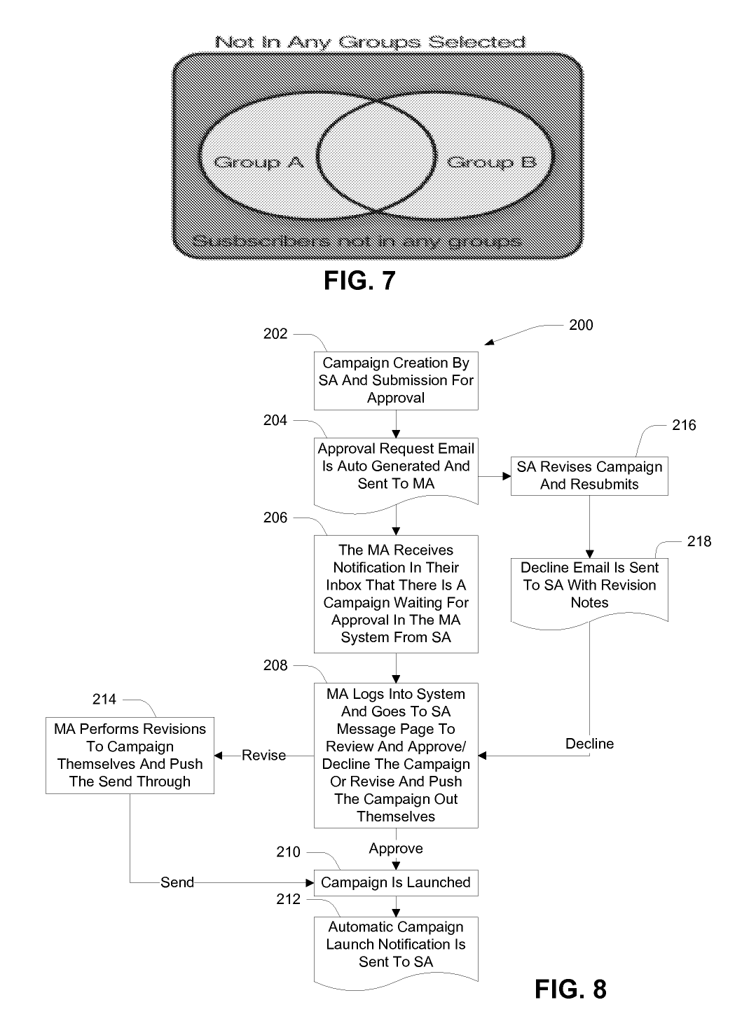

In another embodiment, group permissions 144 lets the user choose which database groups the sub account can access to send to, search upon, or view said group. Clicking the box next to a group gives the sub account user access to it. Leaving a group unchecked will make it completely invisible to the user, ensuring the sub account does not have access to that group. The check all checkbox allows the master account to select or de-select all of the displayed groups. If groups exist in the master accounts account, then they have the option of giving permission on a group-by-group basis to the sub account. The sub account is not allowed to see any groups they do not have access to. This includes in the message-sending processes where they will not be allowed to see groups they do not have permissions to in the choose recipients dialogue. Other areas include import, export, and bulls eye in selecting groups and they must reflect which groups to which the sub account has permissions. Also, in the search subscribers section, the group list that appears accurately reflects on the groups they have permission to see, and they are required to choose a group when searching upon whatever other search criteria they enter. For a “restricted” sub account, “All Contacts” has been replaced with an “All Groups” checkbox that only selects all the groups and does not allow the Sub Account to send to subscribers who are in the “not in any group” pool. FIG. 7 shows a Venn diagram of a pool of subscribers. If they are an unrestricted sub account, however, they can send to “All Contacts” just like a regular master account can. In searching for subscribers, they are not required to select a group because they also have access to this same pool of subscribers outside of any group.

### Image Library Permissions

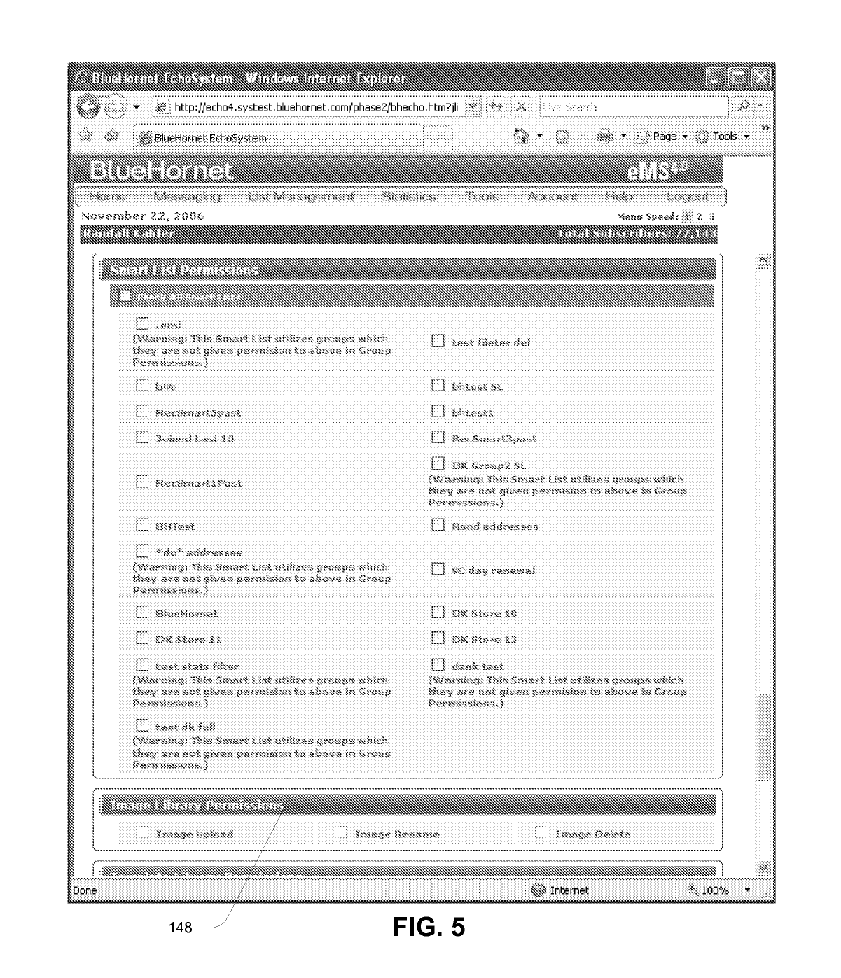

Furthermore, Image Library Permissions 148, shown in FIG. 5 are another aspect. If the user has checked the “Image Library” box 150 in the Feature Set above, this section will be available. If not, these checkboxes will be disabled. Available options in Image Library Permissions lets the administrator give the user the ability to upload images to the image library, rename images, delete images, or any combination of the three. If the user has the Image Library feature selected in the Feature Set permissions but selected no Image Library Permissions options in this section, the sub account user will be able to access and view images in the Image Library, and will be able to insert them in emails, but will not be able to upload, rename or delete images.

### Template Library Permissions

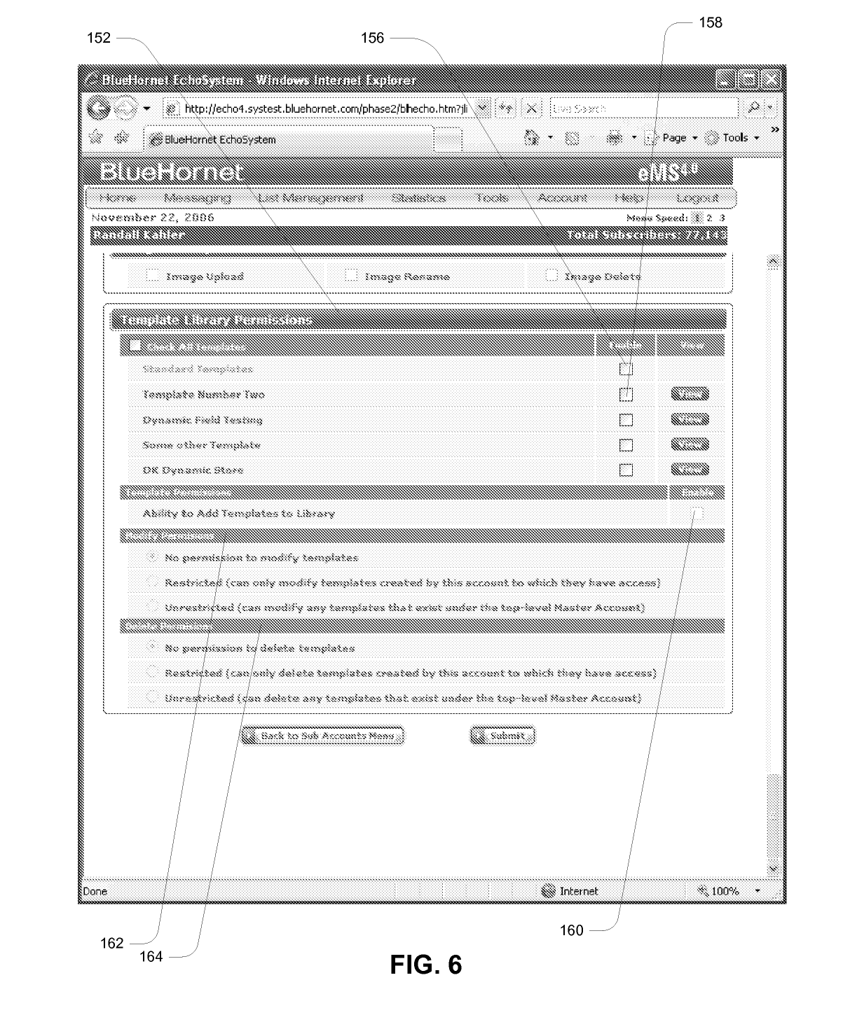

Accordingly, there are also Template Library Permissions 152 features as shown in FIG. 6. This section will be activated if the user checked the Template Library box 154 in the Feature Set permissions section. Template Library Permissions lets the user specify which templates the sub account can access. Standard templates (if available) can be enabled 156 or the user may choose to enable specific custom templates 158 if the user has them. The user may also allow 160 the sub account user to add custom templates to the library. The user can set up permissions for each custom template on an account-by-account basis for each sub account. These permissions are reflected on the template library management page, the template section of the message wizard, and in the template popup. By default, any custom template added by a sub account user will be available only to that sub account for use; other sub accounts will not be able to view or use that template. The user can also specify permissions for updating 162 and deleting 164 custom templates. If a sub account user creates a new custom template, the administrator can specify whether the user can modify the template or delete it in the future.

Furthermore, when enabled (checked), the “Create a Template” table in the template library management page appears with access to create new templates with template builder and to upload a new template. When disabled (unchecked), the “Create a Template” table disappears from the template library management page.

The administrator may also modify permissions. For instance, if there is no permission to modify templates, the edit column is removed from the sub account's own template library management page. If it is restricted (can only modify templates created by this account to which they have access), an “Edit” button only appears next to the custom templates that were created by this sub account. If unrestricted (can modify any templates that exist under the top-level master account), an “Edit” button appears next to all custom templates.

The administrator may also delete permissions. For instance if there is no permission to delete templates, the delete column is removed from the sub account's own template library management page. If it is restricted (can only delete templates created by this account to which they have access), a “Delete” button is only appears next to the custom templates that were created by this sub account. If unrestricted (can delete any templates that exist under the top-level Master Account), a “Delete” button appears next to all custom templates.

### Editing Sub Accounts

To edit an existing sub account, the user navigates, as shown in FIG. 1, to “:Account” 102, then “Sub Accounts” 104, and then finally to “Manage Accounts”. The user will see a table listing all the subaccounts currently in the system. To make modifications to an existing sub account, the user simply clicks on the name of the sub account 103, or on the “EditNiew” button 105 to the right of the account name.

### Deleting Sub Accounts

In a preferred embodiment of the invention, the administrator may delete sub accounts. To delete a sub account, the user navigates to “Account”, then “Sub Accounts” and then to “Manage Accounts.” The user will see a table listing all the sub accounts currently in the system. To delete an existing sub account, the user checks the box 100 to the right of the sub account, and clicks on the “Delete Selected” button 101 at the top or bottom of the sub account list. The user will then be asked to confirm the delete request.

To delete multiple sub accounts at one time, the user may select multiple checkboxes 100. The user will get a single confirmation screen for all checked subaccounts when they click the delete button 101. To delete all subaccounts at once, the user clicks the “Check All” option 107 at the top or bottom of the subaccount list.

### Message Approval Tool

FIG. 8 illustrates a message approval process flow diagram 200. First, a campaign is created by the sub account user. When the message approval is turned on and the sub account reaches the final page of either sending process, the “Submit” button is replaced with a “Submit for Approval” button 202. It will be understood that in FIG. 8, “SA” stands for sub account and “MA” stands for master account.

Again referring to FIG. 8, the message is not immediately sent out, but flagged as “QA” if meant to go out immediately, but needs approval, or “QATR” if it is a Time-Release message that also needs approval. Then, the message is sent 204 to the administrator email address. This is automatically generated. This message contains the following information: account name of the sub account requesting message approval, message subject of the message awaiting approval and time when the message is supposed to go out (either immediately or some date in the future as defined in the time release section of the message sending process). The message also contains a link back to the appropriate domain for the master account to log in, affected areas of text, and time of message sent in scheduling step. For example, “Today” may be changed to “as soon as possible.

### Message Approval Administration

The next step in FIG. 8 is where the master account administrator logs into the sub account system and goes to the sub account message page to review and approve/decline the campaign. The master account administrator may also revise and push the campaign out themselves. Messages awaiting approval are displayed 208 with the following information: date created, to be sent, account name, email subject, and a review button. Messages sent back to the sub account for revision are displayed with the following information: date created, to be sent, account name, email subject and revision notes with a view button. Clicking on the view button reveals any and all of the revision notes for each particular message, displaying the time the revision message was logged and the revision text as entered by the master account.

Messages that have been approved are displayed (with month selection dropdown). Both time released and messages intended to go out immediately, with the following information: date sent (messages already approved and sent display their send time, and time release messaged approved but not yet sent are displayed with their scheduled time of send, prefixed with “scheduled:” text), account name, email subject, message content review displayed in a “View” column, and statistics link (statistics for sent messages displayed with a “Stats” button and time release messages still waiting to be sent display “n/a”).

Next, if the master account administrator approves the campaign, the message will be sent out 210. Also, an automatic campaign launch message 212 is sent to the sub account user. Master accounts must approve of each section by checking the checkbox next to each of the sections of message subject, from, senders email address, reply email address, substitute name, message notes, and billing code. The approve message content has HTML/Rich Text with a “Preview” popup, AOL with a “Preview” popup, plain text with a “Preview” popup, and spam rating with a “Check the SPAM rating of this message” popup. In approving message recipients, the groups section displays all groups to be sent to and the total subscribers section displays the number of total subscribers to be sent to, or “Count still pending”, if the count has not yet finished. An approve message sending date is either immediately or a scheduled date. Moreover, an approve link tracking displays the link append value for the message. It also displays the rich text links with each corresponding easy to remember name shortened as “EZ Name.” It displays the plain text links with each corresponding easy to remember name shortened as “EZ Name.”

The master account administrator may wish to revise 214 the message before approving it. Master account administrator would then perform revisions to campaign themselves and push the send through. Then the campaign would be automatically launched 210. If the master account administrator declines the message 216, then the sub account user may revise the message and resubmit. If the message still fails to meet the master account administrator's approval, the sub account user is sent a decline email with revision notes 218. It will be understood that this process may repeat itself indefinitely until the campaign meets approval.

Finally, if a sub account has an edit group feature turned on and they create a new group, then they should by default have permissions for that group moving forward. If a sub account has specific group permissions and import turned on, then during the import process they must choose a group to import into (as opposed to importing into “all subscribers” pool). If export is turned on then the sub account should only have permission to export subscribers in groups they have access to. If group exclusion is turned on then permitted groups selectable in the exclude column only, and only the permitted groups selectable in the include column.

The master client account will be able to turn on/off any feature that has been made available to them trough the main administrator. The features that are available to sub accounts will be visible and accessible through the system main navigation. Features that are turned off for a sub account will be invisible and inaccessible from the main navigation. Features which can be turned on/off include: standard survey, edit groups, edit categories, and custom fields. Features available for enabling include quick text message, rich text message, message wizard, bulls eye, import subscribers, export subscribers, timed release, template library, image library, welcome letters, refer a friend, even reminders, forward to a friend, customize default email footer, search preferences, search subscribers, advanced messages, random sampler, sending range, click—through target change, group exclusion, add subscribers, opt out subscribers, statistics, edit accounts, group splitters and link appends.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What is claimed is:

1. A computerized sub accounts system for use on a network having a master account and a sub account, comprising:
a database storing permissions granted to the sub account by the master account, each permission allows the sub account access to changing an aspect of a message or campaign;
a software module operatively configured to accept changes from the sub account to content of a message based on permissions granted by the master account; and
an email campaign manager operatively configured to send the message to a customer over the network based upon permissions granted by the master account.

2. The sub accounts system of claim 1 wherein the permission comprises granting access campaign reporting statistics.

3. The sub accounts system of claim 1 wherein the permission comprises granting access to change a header field of a message.

4. The sub accounts system of claim 1 wherein the permission comprises granting access to send a message without master account approval.

5. The sub accounts system of claim 1 wherein the permission comprises granting access to send a message only after master account approval.

6. The sub accounts system of claim 1 wherein the permission comprises granting access to change a link append value of a message.

7. The sub accounts system of claim 1 wherein the permission comprises granting access to change message frequency.

8. The sub accounts system of claim 1 wherein the permission comprises granting access to change a footer field of a message.

9. The sub accounts system of claim 1 wherein the permission comprises granting access to change feature set permissions.

10. The sub accounts system of claim 1 wherein the permission comprises granting access to change template library permissions.

11. A method for managing sub accounts on a network having a master account and a sub account, comprising steps of:
storing permissions granted to the sub account by the master account, each permission allows the sub account access to changing an aspect of a message or campaign;
accepting changes from the sub account to content of a message based on permissions granted by the master account; and
sending the message to a customer over the network based upon permissions granted by the master account.

12. The method of claim 11 wherein the permission comprises granting access campaign reporting statistics.

13. The method of claim 11 wherein the permission comprises granting access to change a header field of a message.

14. The method of claim 11 wherein the permission comprises granting access to send a message without master account approval.

15. The method of claim 11 wherein the permission comprises granting access to send a message only after master account approval.

16. The method of claim 11 wherein the permission comprises granting access to change a link append value of a message.

17. The method of claim 11 wherein the permission comprises granting access to change message frequency.

18. The method of claim 11 wherein the permission comprises granting access to change a footer field of a message.

19. The method of claim 11 wherein the permission comprises granting access to change feature set permissions.

20. The method of claim 11 wherein the permission comprises granting access to change template library permissions.
